(19) United States
(12) Patent Application Publication
(10) Pub. No.: US 2008/0053910 A1
(43) Pub. Date: Mar. 6, 2008

(54) Water-Softening Method

(75) Inventors: Francesc Ayats, Barcelona (ES); Fabio Corradini, Mira (IT); Mark Laing, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 10/597,396

(22) PCT Filed: Feb. 7, 2005
(86) PCT No.: PCT/GB05/00427

§ 371 Date: Oct. 31, 2007

(30) Foreign Application Priority Data
Feb. 7, 2004 (GB) 0402696.9

(51) Int. Cl. B01J 47/12; B01J 20/28

(52) U.S. Cl. 210/687; 210/502.1

(57) ABSTRACT

This invention relates to a method of water-softening using a water-softening product and products useful in such methods. The invention describes such products and processes wherein a change to the product occurs during the water-softening process.

This invention relates to a method of water-softening using a water-softening product and products useful in such methods. The invention describes such products and processes wherein the product is protected in a wrapping having a Moisture Vapour Transmission Rate (MVTR) of less than 30 g/m²/day.

It is well known that certain metal compounds, notably calcium compounds, have a significant effect on the properties of water. “Hard” water containing a significant loading of soluble calcium and magnesium compounds form a scum with soap or detergent and may require a larger amount of detergent in order to provide an efficient clean. Scale deposits can readily form from such water, for example on heating or pH change or evaporation. These deposits can be encrustations, or watermarks left on evaporation of water droplets from, especially, a shiny surface. In addition hard water can form encrustations on fabric washed using such water giving a harsh feel to the fabric.

There have been many proposals for the removal of metal ions from aqueous solutions. In the industrial context proposals have included filter beds and polymeric filters for capturing heavy metal ions from an aqueous solution flowing within a passageway. Examples are given in EP-A-992238 and GB-A-20869564. In the domestic context sequestrants can be added to an aqueous washing solution and these can capture metal ions, such as calcium ions. Examples of such sequestrants are given in EP-A-892040.

However, consumers can be sceptical as to the benefits derived from the use of water-softening products since the benefits are not immediately obvious after a single use of the product, the benefits accumulate over time, for example preventing encrustation of heating elements or encrustation of deposits onto the fabric. Typically the water-softening product is consumed during the washing process and is washed away, such as in the use of powder, tablets or liquid products.

In a multi-step washing process, such as that carried out by a clothes washing machine, it can be a problem that the water-softening product is discharged with the waste water, at an intermediate stage of the process, and is not available for later stages.

WO0218533 and WO0218280 describe water-softening products that are not necessarily consumed during washing processes, because they are not water-soluble, and which are too large to be washed away during any rinsing step.

We have found that such products are not sufficiently chemically stable over extended periods, months, when the product may be stored in a warehouse, shelf or consumer's house prior to use. Therefore, there is a need to develop a system of improving the chemical stability of such products.

In accordance with a first aspect of the present invention there is provided a method of softening water, wherein hard water is contacted with a container and containing one or more water-softening agents able to bind calcium ions, the container having an enclosing wall wherein at least part, preferably all, of the wall is permeable to the water and to components dissolved therein characterised in that the product is stored and removed prior to use from packaging having a moisture vapour transmission rate of less than 30 g/m²/day.

Preferably, the water to be softened is cleaning water. By cleaning water we mean water that contains a surfactant. Alternatively the water to be softened is to be used for cleaning, such that a surfactant is to be added to the water. Preferably any surfactant is added separately to the water-softening product. Therefore, the water-softening product contains less than 1% wt of a surfactant, and/or a bleach. Alternatively a surfactant and/or a bleach may be present in the water-softening product.

We present as a subsequent feature of the invention a water-softening product comprising a container containing one or more water-softening agents, the container having an enclosing wall wherein at least part, preferably all, of the wall is permeable to water and to components dissolved therein, the container being held within a package having a moisture vapour transmission rate of less than 30 g/m²/day.

Preferably at least one water-softening agent is sensitive to the vapour pressure of moisture, by the use of such a term we mean that in the presence of 30% humidity or more at a temperature of greater than 25° C. for a period of 2 weeks or more, the performance of the water softening agent has reduced, preferably by at least 5%. Ideally the majority of the water softening agent is sensitive to moisture by which is meant more than 50% by weight, preferably more than 60%, more preferably more than 70% but less than 99%, more preferably 95%, even more preferably less than 85%. Many water-softening agents are sensitive to moisture by virtue of the fact that their mode of action is to sequester calcium ions.

By substantially water-insoluble water-softening agent we mean an agent, more than 50% wt, preferably at least 70% wt, more preferably at least 85% wt and most preferably at least 95% wt, and optimally 100% wt, of which is retained in the product, when the product is used under the most rigorous conditions for which it is intended (90° C.).

A method of softening water may be a method used in a ware washing machine, for example a clothes washing machine or a dishwashing machine. Preferably the product is able to work through the wash and the rinse cycle of the machine; or only in the rinse cycle, or just in the washing cycle.

Alternatively a method in accordance with the invention may be a manual method, for example using a hand-cloth or mop, and an open vessel, for example a bucket or bowl. Thus, the cleaning method could be a method of cleaning a hard surface, for example a window, a tiled surface, shower screen, dirty tableware and kitchenware, a sanitaryware article, for example a lavatory, wash basin or sink, a car (which we regard as a “household article” within the terms of this invention) or a kitchen worktop.

The packaging may be formed from a sheet of flexible material. Materials suitable for use as a flexible sheet include mono-layer, co-extruded or laminated films. Such films may comprise various components, such as poly-ethylene, poly-propylene, poly-styrene, poly-ethylene-terephtalate or metallic foils such as aluminium foils. Preferably, the packaging system is composed of a poly-ethylene and bi-oriented-poly-propylene co-extruded film with an MVTR of less than 30 g/day/m² . The MVTR of the packaging system is preferably of less than 25 g/day/m², more preferably of less than 22 g/day/m² . The film may have various thicknesses. The thickness should typically be between 10 and 150 μm, preferably between 15 and 120 μm, more preferably between 20 and 100 μm, even more preferably between 30 and 80 μm and most preferably between 40 and 70 μm.

Among the methods used to form the packaging over the container are the wrapping methods disclosed in WO92/20593, including flow wrapping or over wrapping. When using such processes, a longitudinal seal is provided, which may be a fin seal or an overlapping seal, after which a first end of the packaging system is closed with a first end seal, followed by closure of the second end with a second end seal. The packaging system may comprise re-closing means as described in WO92/20593. In particular, using a twist, a cold seal or an adhesive is particularly suited. Alternatively the packaging may be in the form of a sealable bag that may contain one or more (greater than ten but less than forty) sachets.

MVTR can be measured according to ASTM Method F372-99, being a standard test method for water vapour transfer rate of flexible barrier materials using an infrared detection technique.

A product may be disposed in a clothes washing machine throughout the wash and rinse cycles, for example by being placed in the machine's drum with laundry to be washed. Alternatively a product may be disposed in the rinse and/or the wash portion of the dispensing drawer of a clothes washing machine, such that rinse and/or wash water flowing through the loading drawer and into the machine is rendered lower in calcium ion concentration.

### Water-insoluble Water Softening Agent

A water-insoluble agent could comprise polymeric bodies. Suitable forms include beads and fibres. Examples include polyacrylic acid and algins. The water-insoluble agent could alternatively be an inorganic material, for example a granular silicate or zeolite which is retained by the product walls.

The polymeric bodies may, if not inherently sequestrant, be processed in any of a number of ways. Sequestrant side chains may be grafted onto the bodies, for example using the well-known techniques of radiation grafting or chemical grafting. Radiation grafting is described in WO 94/12545. Chemical grafting is described in GB 2086954A. Alternatively for certain side chains the polymeric bodies may be fabricated (for example melt spun) already bearing the sequestrant side-chains, as described in EP 486934A. In yet other embodiments polymeric bodies not bearing sequestrant side chains may be coated with material which has the side chains. The polymeric bodies may, in effect, be regarded as carrying the side chains by mechanical adhesion. Alternatively they may attach by cross-linking, as described in EP 992283A.

Preferably sequestrant side chains are any side-chains which can be carried by polymeric bodies, and which are able to bind calcium (and preferably other) ions, and whose effectiveness in doing that is not substantially diminished by a cleaning agent. Suitable calcium-binding side-chains include residues of acids, for example of acrylic or methacrylic acid, or carboxylic acids, or of sulphonic acids, or of phosphonic acids. Residues of organic acids are preferred. Particularly preferred are residues of methacrylic or, especially, acrylic acid.

Alternative calcium-binding side chains of polymeric bodies may include amino groups, quaternary ammonium salt groups and iminodicarboxyl groups —N{(CH₂)ₙCOOH}₂, where n is 1 or 2.

Further suitable calcium-binding side chains of polymeric bodies may include acyl groups as described in EP 984095A. These have the formula

—C(O)—X(V) (Z) (M) or —C(O)—X(V) (Z) (S-M′)

where X represents a residue in which one carboxyl group is eliminated from a monocarboxylic acid or dicarboxylic acid;
V represents hydrogen or a carboxyl group;
M represents hydrogen; or

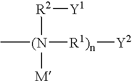

wherein R¹ represents a residue in which one hydrogen is eliminated from a carbon chain in an alkylene group, R² represents a direct bond or an alkylene group, Y¹ and Y² are the same or different and each represents hydrogen, a carboxyl group, an amino group, a hydroxy group or a thiol group, n is an integer of 1 to 4, M′ represents hydrogen or

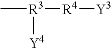

wherein R³ represents a residue in which one hydrogen is eliminated from a carbon chain in an alkylene group; R⁴ represents a direct bond or an alkylene group, Y³ and Y⁴ are the same or different and each represents hydrogen, a carboxyl group, an amino group, a hydroxy group or a thiol group; and Z represents hydrogen or has the same meaning as that of M.

Such side chains are preferably carried by polymeric fibres selected from polyolefins, poly(haloolefins), poly(vinylalcohol), polyesters, polyamides, polyacrylics, protein fibres and cellulosic fibres (for example cotton, viscose and rayon). Polyolefins are especially preferred, particularly polyethylene and polypropylene.

When side chains are grafted onto the base polymeric bodies a preferred process is one using irradiation, in an inert atmosphere, with immediate delivery to irradiated bodies of acrylic acid. Preferably the radiation is electron beam or gamma radiation, to a total dose of 10-300 kGy, preferably 20-100 kGy. The acrylic acid is preferably of concentration 20-80 vol %, in water, and the temperature at which the acrylic acid is supplied to the irradiated polymeric bodies is preferably an elevated temperature, for example 30-80° C. Preferably the base polymeric bodies are polyethylene, polypropylene or cellulosic fibres.

In a preferred feature the water-insoluble agent comprises cation exchange resin. Cation exchange resins may comprise strongly and/or weakly acidic cation exchange resin. Further, resins may comprise gel-type and/or macroreticular (otherwise known as macroporous)-type acidic cation exchange resin. The exchangeable cations of strongly acidic cation exchange resins are preferably alkali and/or alkaline earth metal cations, and the exchangeable cations of weakly acidic cation exchange resins are preferably H⁺ and/or alkali metal cations. Suitable strongly acidic cation exchange resins include styrene/divinyl benzene cation exchange resins, for example, styrene/divinyl benzene resins having sulfonic functionality and being in the Na′ form such as Amberlite 200, Amberlite 252 and Duolite C26, which are macroreticular-type resins, and Amberlite IR-120, Amberlite IR-122, Amberlite IR-132, Duolite C20 and Duolite C206, which are gel-type resins. Suitable weakly acidic cation exchange resins include acrylic cation exchange resins, for example, Amberlite XE-501, which is a macroreticular-type acrylic cation exchange resin having carboxylic functionality and being in the H⁺ form, and Amberlite DP1 which is a macroreticular-type methacrylic/divinyl benzene resin having carboxylic functionality and being in the Na⁺ form.

Other forms of water-insoluble ion exchange agents can be used—such agents include alkali metal (preferably sodium) aluminosilicates either crystalline, amorphous or a mixture of the two. Such aluminosilicates generally have a calcium ion exchange capacity of at least 50 mg CaO per gram of aluminosilicate, comply with a general formula:

0.8-1.5 Na₂O.Al₂O₃.0.8-6 SiO₂

and incorporate some water. Preferred sodium aluminosilicates within the above formula contain 1.5-3.0 SiO₂ units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, and mixtures thereof. Also of interest is zeolite P described in EP 384070 (Unilever).

Another class of compounds are the layered sodium silicate builders, such as are disclosed in U.S. Pat. No. 4,464,839 and U.S. Pat. No. 4,820,439 and also referred to in EP-A-551375.

These materials are defined in U.S. Pat. No. 4,820,439 as being crystalline layered, sodium silicate of the general formula

NaMSiₓO_{2x′1}.YH₂O

where

M denotes sodium or hydrogen,

x is from 1.9 to 4 and y is from 0 to 20.

Quoted literature references describing the preparation of such materials include Glastechn. Ber. 37,194-200 (1964), Zeitschrift für Kristallogr. 129, 396-404 (1969), Bull. Soc. Franc. Min. Crist., 95, 371-382 (1972) and Amer. Mineral, 62, 763-771 (1977). These materials also function to remove calcium and magnesium ions from water, also covered are salts of zinc which have also been shown to be effective water softening agents.

In principle, however, any type of insoluble, calcium-binding material can be used.

Preferably the water-insoluble water softening agent is also able to bind magnesium ions as well as calcium ions.

### Water-Soluble Water Softening Agents

Preferably the product also includes water-soluble water softening agents that are capable of being washed away from the product. By the term “water-soluble” we include agents that are water dispersible. Such agents include

1) Ion capture agents—agents which prevent metal ions from forming insoluble salts or reacting with surfactants, such as polyphosphate, monomeric polycarbonates, such as citric acid or salts thereof.

2) Anti-nucleating agents—agents which prevent seed crystal growth, such as polycarbonate polymers, such as polyacrylates, acrylic/maleic copolymers, phosphonates, and acrylic phosphonates and sulfonates.

### Water-Softening Agents Sensitive to Moisture

### These include but are not limited to polyacrylates, cation exchange resins, citric acid and salts thereof.

### Container

Preferably the container is formed into a flat container or a sachet from a bag or sandwich of sheets that form the walls of the container, having at least one perforated outer wall, for example of a woven, knitted or preferably non-woven material, of textile or paper. The material is in the form of single layer or laminated sheets. Preferably the wall comprises a sheet with a ply of one, two or three layers, such that any insoluble agent inside the container is too large to pass through the perforation(s) or must follow an impossible tortuous pathway if it were to exit the container through the wall. Preferably the sheet is a woven or non-woven material.

The wall of a container may conveniently consist of two sheets secured together about their periphery, with the contents therebetween. The securement may be by means of adhesive or dielectric welding or, preferably, heat sealing or, most preferably, ultrasound sealing. When the securement is by heat sealing the sheets may comprise a thermoplastic to facilitate this. The material forming the adhesive strips can be a so called hot melt comprising various materials, such as APP, SBS, SEBS, SIS, EVA and the like, or a cold glue, such as a dispersion of various materials, e.g. SBS, natural rubber and the like, or even a solvent-based or a two-component adhesive system. Furthermore, the material may be capable of crosslinking to form specific, permanent chemical bonds with the various layers. The amount of adhesive is a function of the type of adhesive used, however it is generally between 0.2 and 20 g/m².

Conventional materials used in tea bag manufacture or in the manufacture of sanitary or diaper products may be suitable, and the techniques used in making tea bags or sanitary products can be applied to make flexible products useful in this invention. Such techniques are described in WO 98/36128, U.S. Pat. No. 6,093,474, EP 0708628 and EP 380127A.

The product could be discarded after use, or it could be regenerated when certain water-softening agents are used, for example cation exchange resins by using sodium chloride to effect ion exchange, and re-used.

In addition to a substantially water-insoluble water-softening agent the container could contain a water-soluble solid material or a dispersible solid material which can pass through the walls of the container when immersed in water. Such a water-soluble or dispersible solid material could be, for example, any of the materials mentioned above as being possible components of compositions with which the product can be used; but particularly includes a cleaning surfactant or a bleach activator.

However, and preferably, the container is substantially free of any surfactant and/or source of active oxygen. By substantially free we mean less than 5% wt, less than 2% wt, less than 1% wt, ideally less than 0.5% wt.

Furthermore the wall of the container may itself act as a further means for modifying the water, for example by having the capability of capturing undesired species in the water and/or releasing beneficial species. Thus, the wall material could be of a textile material with ion-capturing and/or ion-releasing properties, for example as described above, such a product may be desired by following the teaching of WO 0218533 that describes suitable materials.

The product may be a rigid body which is shaped to locate snugly in the tray such that the inflowing rinse water is compelled to flow through it. Alternatively it may be a flexible body, for example a bag, which packs into the flow pathway for the rinse water such that the rinse water is compelled to flow through it. This is an efficient approach to softening the water used in clothes washing machines. Suitably the main wash water will not have flowed through the product, but softening thereof is effected by the conventional builders present in the laundry detergent composition. Prior to rinsing, the wash water containing the builders is drained away and only then is the rinse water delivered into the machine, this rinse water having been softened by flowing through the product located in the loading tray. Neither the builders nor the sequestrant in the product are active at the same time as the other. Thus, they do not compete with each other and are not used wastefully.

In accordance with a further aspect of the invention there is provided a method of providing improved cleaning in a clothes washing machine, wherein a product containing a substantially water-insoluble water softening agent, having a wall permeable to water and to metal ions therein but impermeable to the agent is located in the machine such that hard water flows through the product, thereby effecting the softening of the water in the machine characterised in that the product is stored and removed prior to use from packaging having a MVTR of less than 30 g/m²/day.

The invention will now be described, by way of example, with reference to the following embodiments.

| Actives in Sachet | Amt | Wt. % | Amt | Wt. % | Amt | Wt. % | Amt | Wt. % | Amt | Wt. % | Amt | Wt. % |
|---|---|---|---|---|---|---|---|---|---|---|---|---|
| Acrylic acid | 5.00 | 42.7 | 6.00 | 56.1 | 3.84 | 29.0 | 4.80 | 28.6 | 5.00 | 39.3 | 4.00 | 34.8 |
| homopolymer | | | | | | | | | | | | |
| Citric Acid | 2.85 | 24.4 | 3.00 | 28.0 | 5.43 | 41.0 | 6.79 | 40.4 | 2.85 | 22.4 | 2.50 | 21.7 |
| Phosphonate | 0.10 | 0.9 | 0.15 | 1.4 | 0.10 | 0.8 | 0.10 | 0.6 | 0.10 | 0.8 | 0.10 | 0.9 |
| chelating agent | | | | | | | | | | | | |
| Cation Exchange | 3.00 | 25.6 | 1.10 | 10.3 | 3.00 | 22.6 | 4.00 | 23.8 | 4.00 | 31.4 | 4.00 | 34.8 |
| Resin | | | | | | | | | | | | |
| Water absorbent | 0.25 | 2.1 | 0.25 | 2.3 | 0.80 | 6.0 | 0.90 | 5.4 | 0.70 | 5.5 | 0.70 | 6.1 |
| polymer | | | | | | | | | | | | |
| Esterquat | 0.50 | 4.3 | 0.20 | 1.9 | 0.09 | 0.68 | 0.20 | 1.2 | 0.085 | 0.67 | 0.20 | 1.7 |
| Total (grams) | 11.7 | | 10.7 | | 13.26 | | 16.79 | | 12.74 | | 11.5 | |

The sachet was made from Polypropylene nonwoven sheets Lutrasil™ available from Freudenberg Nonwovens. The sachets were made in accordance with the technical teachings of WO 98/36128 and EP 380127A.

Ten sachets were held in a bag made from the following material and stored in a standard non-waxed cardboard box. In addition ten identical sachets were stored in the same standard non-waxed cardboard box but without being packed in the bag. Storage conditions were at 30° C. at 70% relative humidity for 6 weeks. After storage the sachets were inspected for visible degradation. The sachets not stored in the plastic bag had visibly deteriorated.

Packaging Description

Bags were made from reeled polythene film, 380 mm wide.

| | | THICKNESS |
|---|---|---|
| GENERIC NAME | MANUFACTURER | (μm) |
| Polyethylene | ASPLA, Torrelavega | 60 |
| LDPE-LLDPE | (Santander, Spain) | |

| PERFORMANCE | | Value |
|---|---|---|
| 1.1 | Tensile strength (Machine Direction) | >20 N/MM2 |
| 1.2 | Coefficient of friction:- | |
| | Internal | <0.25 |
| | External | <0.25 |
| 1.3 | Barrier properties | |
| | Oxygen transmission | 4000 cc/m²/24 hr |
| | Water vapour transmission | 20 grs./m²/24 hr |

Supplier—Aspla of Snatander Spain

1. A method of softening water, wherein hard water is contacted with a container containing one or more water-softening agents able to bind calcium ions, the container having an enclosing wall wherein at least part, of the wall is permeable to the water and to components dissolved therein characterised in that the product is stored and removed prior to use from packaging having a moisture vapour transmission rate of less than 30 g/m^{2/}day.

2. A method according to claim 2 wherein least one water-softening agent is substantially water-insoluble.

3. A method according to claim 1 wherein the method is a method used in a ware washing machine.

4. A method according to claim 1 wherein at least one water-softening agent is a cation exchange resin.

5. A water-softening product comprising a container containing one or more water-softening agents, the container having an enclosing wall which in at least part, of the wall is permeable to water and to components dissolved in, the container being held within a package having a moisture vapour transmission rate of less than 30 g/m²/day.

6. A water-softening product as claimed in claim 5 wherein at least one water-softening agent is water-soluble.

7. A water-softening product according to claim 5 wherein the container is a flat container.

8. A water-softening product according to claim 7 wherein the container wall comprises a sheet.

9. A water-softening product according to claim 8 wherein the sheet is a woven or non-woven material.

10. A water-softening product according to claim 5 according to claim 5 wherein the packaging is formed from a sheet of flexible material.

11. A method of providing improved cleaning in a clothes washing machine, wherein a product containing a substantially water-insoluble water softening agent, having a wall permeable to water and to metal ions therein but impermeable to the agent is located in the machine such that hard water flows through the product, thereby effecting the softening of the water in the machine characterised in that the product is stored and removed prior to use from packaging having a MVTR of less than 30 g/m²/day.

12. A water-softening product according to claim 5 wherein the container is a sachet.
